(19) United States
(12) Patent Application Publication
(10) Pub. No.: US 2019/0074097 A1
(43) Pub. Date: Mar. 7, 2019

(54) METHOD OF DETERMINING CONDITIONS FOR ACCOMMODATING RADIOACTIVE WASTE IN CONTAINER, RADIOACTIVE WASTE ACCOMMODATING METHOD, AND WASTE BODY PRODUCED USING SAID METHOD

(71) Applicant: MITSUBISHI HEAVY INDUSTRIES, LTD., Tokyo (JP)

(72) Inventors: Tomohisa Okamoto, Tokyo (JP); Noboru Kurokawa, Tokyo (JP); Toshiya Komuro, Tokyo (JP); Toshimitsu Umakoshi, Tokyo (JP); Naotaka Komatsu, Tokyo (JP)

(73) Assignee: MITSUBISHI HEAVY INDUSTRIES, LTD., Tokyo (JP)

(21) Appl. No.: 15/739,400

(22) PCT Filed: Aug. 25, 2016
(86) PCT No.: PCT/JP2016/074890

§ 371 Date: Dec. 22, 2017

(30) Foreign Application Priority Data
Oct. 16, 2015 (JP) 2015-204470

(51) Int. Cl. G21F 5/005; G01T 1/167

(52) U.S. Cl. CPC G21F 5/005; G01T 1/167

(57) ABSTRACT

A container accommodation condition determination method of determining an accommodation condition for accommodating a plurality of waste pieces, obtained by at least cutting radioactive waste, into at least one storage container, for obtaining at least one waste body by accommodating the plurality of waste pieces into the at least one storage container, includes: a step of, assuming, for each of a plurality of arrangement condition candidates specifying the storage container in which each of the waste pieces is to be stored and an accommodation position inside the storage container, that the waste pieces are arranged inside the storage container in accordance with the arrangement condition candidate, selecting at least one of the arrangement condition candidates which satisfy a limiting condition required for the waste body in each of the storage containers; a step of calculating a necessary storage container number which is the number of the storage container required to accommodate the plurality of waste pieces in accordance with the selected arrangement condition candidate; and a step of specifying the arrangement condition candidate such that the necessary storage container number is minimum.

### TECHNICAL FIELD

The present disclosure relates to a method for accommodating waste pieces obtained by cutting radioactive waste efficiently into a storage container, and a waste body produced by the method.

### BACKGROUND ART

Radioactive waste discharged from a nuclear facility, for instance, is stored permanently in a completely sealed state. Thus, the amount of stored radioactive waste keeps increasing year by year, and the storage cost is also rising. Under such a situation, it is desirable to reduce the volume of radioactive waste as much as possible.

Patent Document 1 discloses a cutting volume reduction device for cutting a control-rod cluster guide tube into segments and accommodating the segments into individual storage containers, to enable safe recovery of control-rod cluster guide tubes disposed inside a reactor vessel. Furthermore, Patent Document 2 discloses a volume reduction process of placing a thin board on a cartridge accommodating radioactive waste, pressing the board from above with a compressing device, accommodating another radioactive waste while maintaining the compressed state, and repeating the process of pressurizing from above in turn, before fixing the top part with a lid. Moreover, Patent Document 2 discloses a volume reduction processing device for pulverizing radioactive waste, and compressing an accommodation bag filled with the pulverized matters by evacuation.

### CITATION LIST

### Patent Literature

Patent Document 1: JP2014-098596A

Patent Document 2: JP2000-065990A

Patent Document 3: JP2011-080873A

### SUMMARY

### Problems to be Solved

However, in the accommodation method described in Patent Document 1, there is no measure for improving the efficiency of filling a storage container with the plurality of segments obtained by dividing a control-rod cluster guide tube, and thus the accommodation space inside the storage container is not fully utilized. Thus, the accommodation method described in Patent Document 1 has a problem that an unnecessarily large number of storage containers are required. In other words, in the invention of Patent Document 1, while waste pieces obtained by cutting and reducing the volume of radioactive waste are stored in at least one storage container to produce waste bodies, the amount of waste bodies cannot be reduced. As a result, in the invention of Patent Document 1, the number of waste bodies to be produced increases unnecessarily, and thus the space of a storage building for storing waste bodies until the final disposal is not fully utilized. Furthermore, with the unnecessarily large number of waste bodies being produced, the cost for transporting waste bodies to the storage building also increases.

Furthermore, the cutting volume reducing method of Patent Document 2 is not flexible, for radioactive waste needs to be cut out in accordance with the capacity of the storage container (so that the segments are not too small nor too large compared to the capacity of the storage container), which limits the manner of cutting considerably. Furthermore, radioactive waste with an extremely high radiation level, such as core structure, should not be pulverized into small pieces (e.g. particles), to prevent radioactive contamination from spreading, and thus it is difficult to apply the cutting volume reduction method of Patent Document 3.

In view of the above, an object of at least one embodiment of the present invention is to provide a method for determining conditions for accommodating in a container, by accommodating a plurality of waste pieces efficiently in a storage container to reduce the necessary number of storage containers while satisfying physical limiting conditions required for each waste body, an accommodation method for accommodating the plurality of pieces in a storage container in accordance with the method for determining conditions for accommodating in a container, and a waste body obtained by the method.

### Solution to the Problems

(1) In at least one embodiment of the present invention, a container accommodation condition determination method of determining an accommodation condition for accommodating a plurality of waste pieces, obtained by at least cutting radioactive waste, into at least one storage container, for obtaining at least one waste body by accommodating the plurality of waste pieces into the at least one storage container, comprises: a step of, assuming, for each of a plurality of arrangement condition candidates specifying the storage container in which each of the waste pieces is to be stored and an accommodation position inside the storage container, that the waste pieces are arranged inside the storage container in accordance with the arrangement condition candidate, selecting at least one of the arrangement condition candidates which satisfy a limiting condition required for the waste body in each of the storage containers; a step of calculating a necessary storage container number which is the number of the storage container required to accommodate the plurality of waste pieces in accordance with the selected arrangement condition candidate; and a step of specifying the arrangement condition candidate such that the necessary storage container number is minimum.

Accordingly, at least in an embodiment of the present invention, the storage container in which each waste piece is to be stored and an accommodation position in the storage container are defined by the arrangement condition candidate. Further, in at least one embodiment of the present invention, from among the plurality of arrangement condition candidates, at least one arrangement condition candidate satisfying the limiting condition is selected, and the arrangement condition candidate capable of reducing the number storage containers required to accommodate the plurality of waste pieces is determined as the accommodation condition for accommodating waste pieces in the storage container. The accommodation for the waste pieces obtained as described is a condition among the plurality of arrangement condition candidates, which satisfies the limiting condition of each waste body and is associated with the smallest necessary storage container number.

Therefore, according to at least one embodiment of the present invention, it is possible to accommodate the plurality of waste pieces in the storage container efficiently, and to reduce the necessary number of storage containers, while satisfying the physical limiting condition required for each waste body.

(2) Furthermore, in some embodiments of the present invention, the above method (1) comprises, performing, for each of a plurality of cutting conditions for cutting the radioactive waste, the step of selecting the arrangement condition candidate and the step of calculating the necessary storage container number, and specifying a combination of the cutting condition and the arrangement condition candidate such that the necessary storage container number is minimum.

As described above, according to the above configuration (2), it is possible to define various cutting manners for cutting the radioactive waste to obtain the plurality of waste pieces as the plurality of cutting conditions, and calculate an accommodation condition capable of reducing the number of waste bodies obtained by accommodating the waste pieces in the storage containers for each of the plurality of cutting conditions. As a result, according to the above configuration (2), it is possible to specify the most efficient combination of a cutting condition and an arrangement condition, as an accommodation condition capable of reducing the number of waste bodies by accommodating the waste pieces in the storage containers efficiently.

(3) Furthermore, in some embodiments of the present invention, in the above method (1) or (2), the method further comprises a step of obtaining a dose distribution of the radioactive waste, and the step of selecting the arrangement condition candidate includes selecting the arrangement condition candidate satisfying the limiting condition which at least specifies that a surface dose rate of the waste body is not higher than a threshold on the basis of the dose distribution.

When discarding or storing the waste bodies, it may be necessary to ensure safety and efficiency. The above method (3) is beneficent in such cases. That is, according to the above method (3), the surface dose rate of each waste body is set to be not higher than the threshold on the basis of the dose distribution of the radioactive waste, and thereby it is possible to reduce the number of storage containers required, while ensuring safety and efficiency in discarding or storing the waste bodies.

(4) Furthermore, in some embodiments of the present invention, in the above method (1) or (2), the method further comprises a step of measuring a dose of each of the waste pieces, and the step of selecting the arrangement condition candidate may include selecting the arrangement condition candidate satisfying the limiting condition which at least specifies that a surface dose rate of the waste body is not higher than a threshold on the basis of the dose of the waste pieces.

When discarding or storing the waste bodies, it may be necessary to ensure safety and efficiency. The above method (4) is beneficent in such cases. That is, according to the above method (4), the surface dose rate of each waste body is set to be not higher than the threshold on the basis of the dose distribution of the radioactive waste, and thereby it is possible to reduce the number of storage containers required, while ensuring safety and efficiency in discarding or storing the waste bodies.

(5) Furthermore, in some embodiments of the present invention, in the above methods (1) to (4), the method further comprises a step of storing, in a database, characteristic descriptive information showing a characteristic of each of the plurality of waste pieces, and the step of selecting the arrangement condition candidate may include determining whether the limiting condition required for the waste body is satisfied in each of the storage containers when the waste pieces are arranged in the storage containers in accordance with the arrangement condition candidate, on the basis of the characteristic descriptive information stored in the database.

Accordingly, with the above configuration (5), the operation for selecting the arrangement condition candidate defining the arrangement manner for arranging the waste pieces in the storage container is performed on the basis of the characteristic descriptive information showing the characteristics of each waste piece and thereby it is possible to perform efficient volume reduction in accordance with the characteristics of each, waste piece.

(6) Furthermore, in some embodiments of the present invention, in the above method (5), the character specific information includes at least one of a shape, a weight, or a dose, of each of the waste pieces.

Accordingly, with the above configuration (6), it is possible to select the arrangement condition candidate taking into account the shape, weight, or dose of the waste pieces.

(7) Furthermore, in some embodiments of the present invention, in the above methods (1) to (6), the method further comprises a step of compressing a plurality of segments obtained by cutting the radioactive waste to shape the segments into the plurality of waste pieces having at least one kind of standardized shape.

Accordingly, with the above configuration (7), the waste pieces are accommodated into a storage container after shaping the plurality of waste pieces obtained by cutting the radioactive waste into waste piece having a standardized shape (including dimensions). Thus, with the above configuration (7), it is possible to considerably simplify the computation process for determining the accommodation condition for reducing the amount of waste bodies obtained by accommodating the waste pieces in the storage container. Furthermore, with the above configuration (7), by, designing the standardized shape appropriately, it is possible to calculate an accommodation condition such that it is possible to stuff the waste pieces into the storage container with smallest possible clearance.

(8) Furthermore in some embodiments of the present invention, in the above methods (1) to (7), the limiting condition required for the waste body includes a condition such that at least one of a weight, a surface dose rate, or a heat generation amount, of each of the waste bodies is within an allowable range.

To implement some embodiments of the present invention, it may be necessary to ensure safety and efficiency in works for transporting the waste bodies to a site for long-term storage. Even in such a case, with the above configuration (8), at least one of the dose rate, weight, or heat generation amount of each waste body is set to be within an allowable range on the basis of the dose distribution of the radioactive waste, and thereby it is possible to reduce the number of storage containers required, while ensuring safety and efficiency in the transportation works for the waste bodies.

(9) Furthermore, in some embodiments of the present invention, in the above methods (1) to (8), the plurality of arrangement condition candidates include at least one arrangement condition candidate specifying that, inside each of the storage containers, a first waste piece is accommodated in a first region disposed in a center section of the storage container and a second waste piece is disposed in a second region surrounding the first region in the storage container so as to envelope the first waste piece, the second waste piece having a lower dose than the first waste piece.

According to the above method (9), if the selected arrangement condition candidate defines an arrangement such that the low-dose second waste pieces envelop the high-dose first waste piece, it is possible to reduce the dose that reaches the surface of the waste body thanks to the function as the radiation insulator of the low-dose second waste pieces enveloping the high-dose first waste piece, even in a case where the high-dose first waste piece is accommodated inside the storage container. Thus, if the plurality of arrangement condition candidates include a candidate defining the arrangement manner of the waste pieces according to the above method (9), it is possible to increase the possibility of the arrangement condition candidate satisfying the limiting condition, even in a situation where few storage containers are available and a large number of high-dose waste pieces need to be accommodated in the containers. Thus, a great amount of high-dose waste pieces can be accommodated as compared to a typical accommodation method, and it is possible to increase the filling rate of the waste pieces inside the storage container, which makes it possible to reduce the number of waste bodies compared to a typical accommodation method.

(10) Furthermore, in some embodiments of the present invention, the method may comprises a step of accommodating the waste pieces inside the storage container in accordance with the accommodation condition determined by the container accommodation method determination method according to any one of the above methods (1) to (9) to obtain at least one waste body.

Accordingly, with the above configuration (10), by using the container accommodation condition determining method described in the above (1) to (9), it is possible to implement the embodiments of the present invention as a method of accommodating a plurality of waste pieces in at least one storage container.

(11) In at least one embodiment of the present invention, a method of obtaining at least one waste body by accommodating a plurality of waste pieces, obtained by at least cutting radioactive waste, into at least one storage container, comprises: a step of accommodating a first waste piece in a first region positioned in a center section of the storage container; and a step of accommodating a second waste piece in a second region surrounding the first region in the storage container such that the second waste piece envelops the first waste piece, the second waste piece having a lower dose than the first waste piece.

As described above, in at least one embodiment of the present invention, the relatively low-dose waste pieces are arranged so as to envelop, as a radiation insulator, the relatively high-dose waste piece accommodated in the middle of the storage container. Accordingly, if the selected arrangement condition candidate defines an arrangement such that the low-dose waste pieces envelop the high-dose waste piece, it is possible to reduce the dose that reaches the surface of the waste body thanks to the function as the radiation insulator of the low-dose waste pieces enveloping the high-dose waste piece disposed inside the storage container. Thus, if the plurality of arrangement condition candidates include a candidate defining the arrangement manner of the waste pieces according to the above method (11), it is possible to increase the possibility of the arrangement condition candidate satisfying the limiting condition, even in a situation where few storage containers are available and a large number of high-dose waste pieces need to be accommodated in the containers. Thus, a great amount of high-dose waste pieces can be accommodated as compared to a typical accommodation method, and it is possible to increase the filling rate of the waste pieces inside the storage container, which makes it possible to reduce the number of waste bodies compared to a typical accommodation method.

(12) In at least one embodiment of the present invention, a waste body obtained by accommodating a plurality of waste pieces obtained by at least cutting a radioactive waste into at least one storage container comprises: a first waste piece accommodated in a first region positioned in a center section of the storage container; and a second waste piece accommodated in a second region surrounding the first region in the storage container such that the second waste piece envelops the first waste piece, the second waste piece having a lower dose than the first waste piece.

As described above, the waste body according to the above embodiment (12) is produced such that the low-dose waste pieces are arranged so as to envelop, as a radiation insulator, the high-dose waste piece accommodated in the middle of the storage container. Thus, the waste body according to the above embodiment (12) can accommodate a greater number of high-dose waste pieces in a storage container with a high filling rate, as compared to a typical accommodation method. Furthermore, the waste body according to the above embodiment (12) includes low-dose waste pieces that function as a radiation insulator, surrounding a high-dose waste piece accommodated inside the storage container. Accordingly, the waste body according to the above embodiment (12) can reduce the surface dose rate and heat generation amount of the surface of the waste body effectively even if a high-dose waste piece is accommodated, which makes it possible to facilitate disposal works and storage works for the waste bodies.

### Advantageous Effects

According to at least one embodiment of the present invention, it is possible to accommodate the plurality of waste pieces in the storage container efficiently, and to reduce the necessary number of storage containers, while satisfying the physical limiting condition required for each waste body.

### BRIEF DESCRIPTION OF DRAWINGS

FIG. 1 is a diagram showing an overall flow of a method for processing radioactive waste according to an embodiment of the present invention.

FIG. 2 is a diagram showing a first example of a plurality of arrangement condition candidates according to an embodiment of the present invention.

FIG. 3 is a diagram showing a second example of a plurality of arrangement condition candidates according to an embodiment of the present invention.

FIG. 4 is a diagram showing a corresponding relationship among combinations of cutting conditions and arrangement condition candidates, satisfiability of the limiting conditions, and the necessary number of storage containers.

FIG. 5 is a diagram showing an example of cutting conditions of radioactive waste according to an embodiment of the present invention.

FIG. 6 is a diagram showing a computer system according to an embodiment of the present invention.

FIG. 7 is a flowchart showing a flow of a series of processing operations according to an embodiment of the present invention.

FIG. 8 is a diagram showing an overall flow of a method for processing radioactive waste according to a modified example of the present invention.

FIG. 9 is a diagram showing a process for shaping waste pieces into a standardized shape according to an embodiment of the present invention.

FIG. 10 is a diagram showing a computer system according to the present embodiment of the present invention.

FIG. 11 is a flowchart showing a flow of a series of processing operations according to the present embodiment.

FIG. 12 is a diagram showing waste pieces accommodated in a storage container according to the present embodiment.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not intended to limit the scope of the present invention.

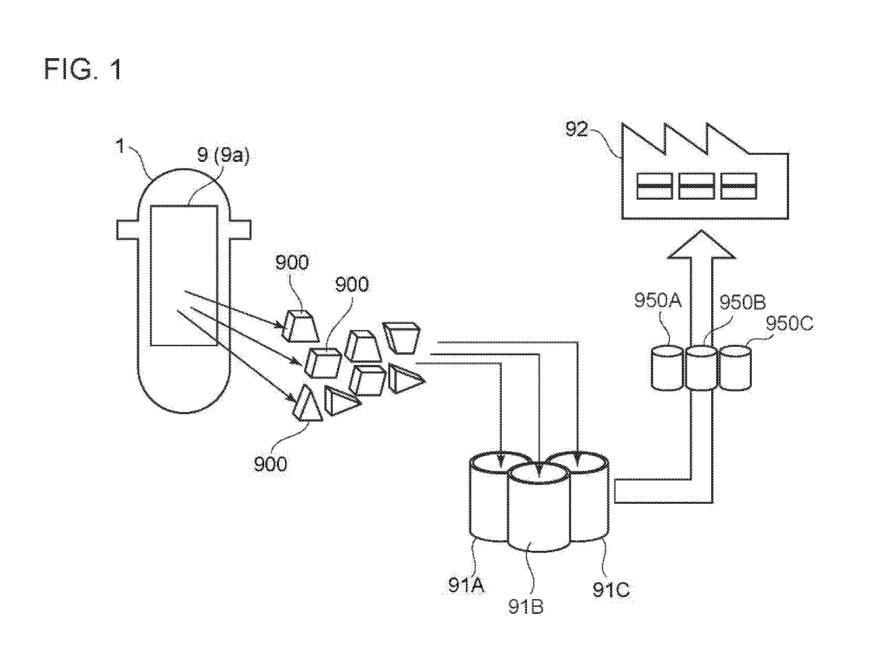

FIG. 1 is a diagram showing an overall flow of a method for processing radioactive waste according to an embodiment. As shown in FIG. 1, in some embodiments, an accommodation condition for accommodating a plurality of waste pieces 900 obtained by at least cutting radioactive waste 9 into at least one storage container 91 (91A to 91C) is determined, and the waste pieces 900 are accommodated in the storage container 91 (91A to 91C) in accordance with the accommodation condition to obtain a waste body 950 (950A to 950C).

Furthermore, in the exemplary embodiment shown in FIG. 1, a reactor internal structure 9a inside a reactor vessel 11 is shown as an example the radioactive waste 9. However, in another embodiment, the radioactive waste 9 may be a reactor vessel, a steam generator, piping, or the like, other than the reactor internal structure. In yet another embodiment, the radioactive waste 9 may be low-level radioactive waste discharged from a nuclear-related facility.

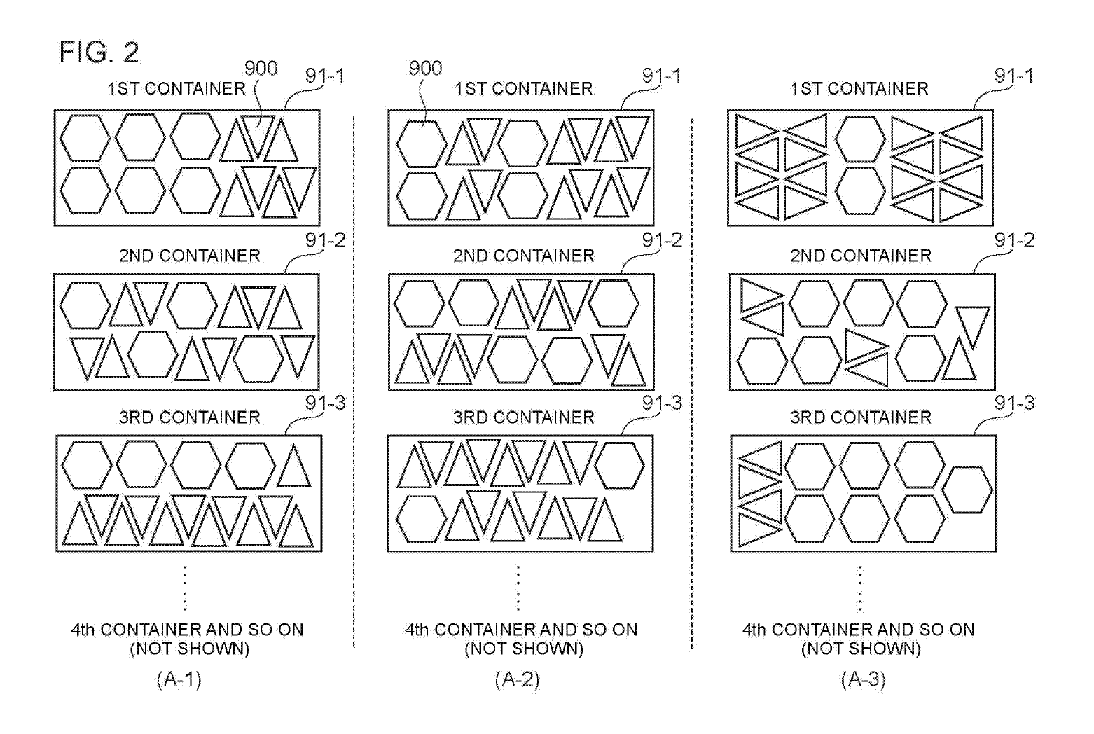

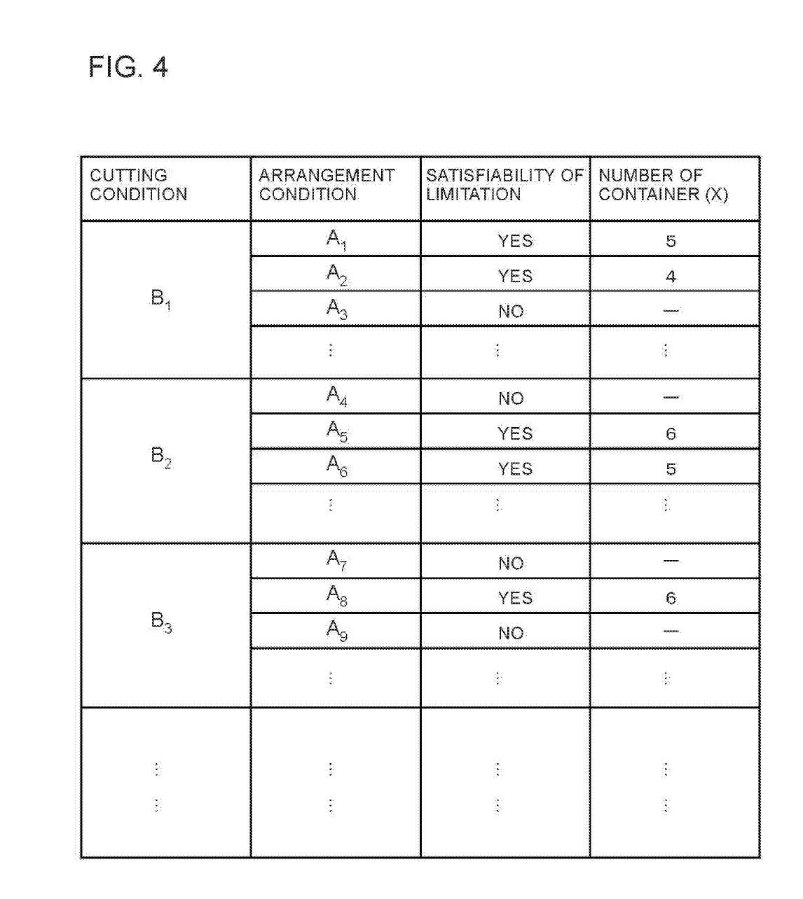

Next, with reference to FIGS. 2 to 4, “arrangement condition candidate” and “limiting condition” will be described. Subsequently, with reference to FIG. 4, a method of determining an accommodation condition for accommodating waste pieces 900 into the storage container 91 will be described in detail.

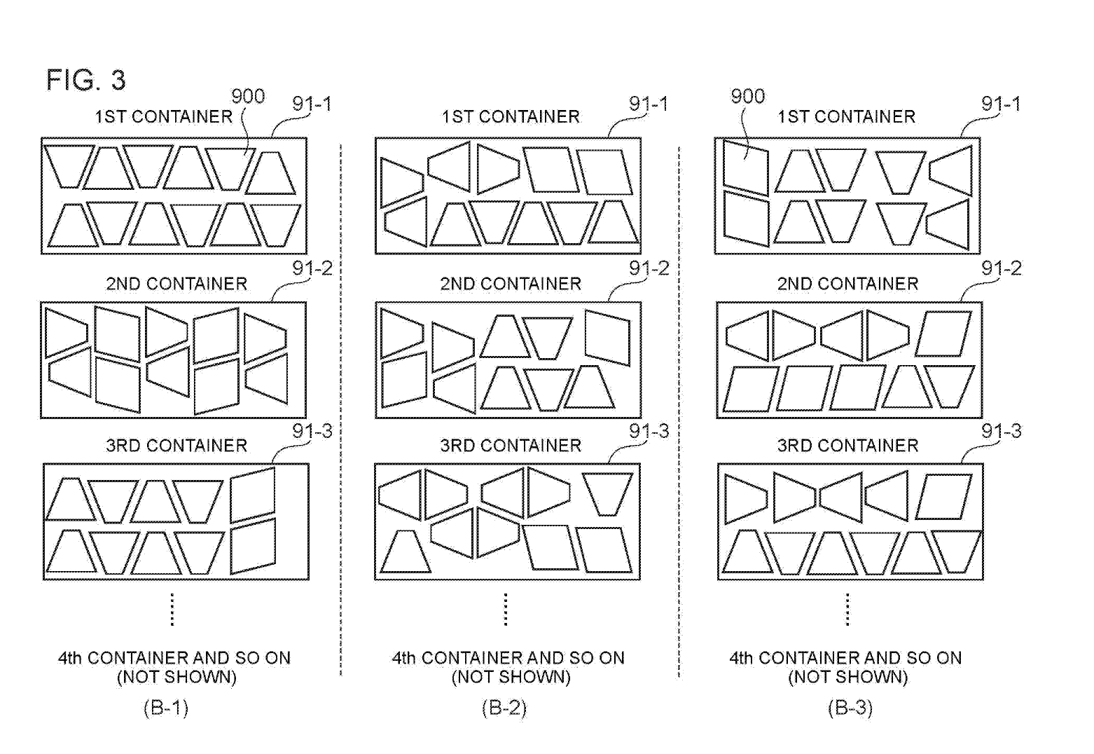

Herein, FIGS. 2 and 3 are each a diagram showing an example of a plurality of arrangement condition candidates used in the waste disposal method shown in FIG. 1. Furthermore, FIG. 4 is a diagram showing a corresponding relationship among, combinations of the arrangement condition candidates, satisfiability of the limiting conditions, and the necessary number of storage containers 91, according to an embodiment of the present invention.

As shown in FIGS. 2 and 3, the respective waste pieces 900 can be accommodated in the storage container 91 (91A to 91C) in different patterns, regarding in which storage container 91 the waste pieces 900 are to be accommodated, and the positions inside the storage container 91. The arrangement condition candidates are conditions that specify such patterns. Specifically, the arrangement condition candidates are conditions that determine which storage container 91 (91A to 91C) is to accommodate each of the waste pieces 900, and the accommodation position inside the storage container 91 (91A to 91C).

Normally, the waste pieces 900 each have a three-dimensional shape (including dimensions) that is random and not uniform. However, in FIGS. 2 and 3, to simplify the description, each waste piece 900 is shown in a simple two-dimensional shape. The drawings show schematic examples where the waste pieces 900 are each accommodated in two-dimensional manner inside a space inside a box-shaped container, shown as a rectangular two-dimensional region. In the examples shown in FIGS. 2 and 3, the waste pieces 900 have different shapes. Furthermore, in the examples shown in FIGS. 2 and 3, the specific accommodation positions of the waste pieces 900 inside the containers are shown only for the first three storage containers 91-1 to 91-3, and the specific accommodation position is not shown for the fourth and following storage containers 91. Furthermore, as an arrangement condition for determining the accommodation manner for accommodating the plurality of waste pieces 900 into at least one storage container 91, other arrangement conditions may be used, besides the arrangement condition shown in FIGS. 2 and 3.

The limiting condition refers to restrictions related to the characteristics of the waste body 950, which are required to be satisfied by the waste body 950 as a whole. In an embodiment, the limiting condition includes a condition such that at least one of weight, surface dose rate, or heat generation amount, of each waste body 950 should fall within an allowable range. In yet another embodiment, the limiting condition includes a condition such that all of weight, surface dose rate, and heat generation amount, of each waste body 950 should fall within an allowable range.

In some embodiments, assuming that the waste pieces 900 are arranged in the storage containers 91 in accordance with each of the N arrangement condition candidates Aᵢ (1≤i≤N, where N is an integer not less than two) as shown in FIG. 4, and it is determined whether the limiting condition required for a waste body is satisfied, in each storage container 91 (91A to 91C). Then, from among the i arrangement condition candidates, one or more arrangement condition candidates satisfying the limiting condition required for a waste body in each storage container 91 (91A to 91C) are selected.

In the exemplary embodiment shown in FIG. 4, the arrangement condition candidates A₁, A₂, A₅, A₆, A₈ are the conditions satisfying the limiting condition.

In some embodiments, when selecting arrangement condition candidates, j (1≤j≤N) arrangement condition candidates are selected, which satisfy the limiting condition that specifies at least the surface dose rate of the waste body 950 (950A to 950C) is not higher than a threshold, on the basis of the dose distribution of the radioactive waste 9. Accordingly, it is possible to reduce the necessary number of storage containers 91 (91A to 91C) while ensuring safety and efficiency of the transportation work for the waste body 950 (950A to 950C).

The method for obtaining the dose distribution of the radioactive waste 9 is not particularly limited. For instance, the dose distribution may be obtained from a result of measurement of the dose distribution of the radioactive waste 9 at a plurality of measurement points, or may be estimated on the basis of the previous radiation exposure history of the radioactive waste 9.

After selecting j arrangement condition candidates A′ⱼ satisfying the limiting condition, subsequently, the number X of storage containers necessary (necessary storage container number) for accommodation of the plurality of waste pieces 900 according to each of the arrangement condition candidates A′ⱼ (1≤j≤N) is calculated. The necessary storage container number X is calculated for each of the arrangement condition candidates satisfying the limiting condition.

After calculating the necessary storage container number X for each of the arrangement condition candidates satisfying the limiting condition, an arrangement condition candidate associated with the smallest necessary storage container number X is specified.

Accordingly, the obtained arrangement condition candidate one of the i arrangement condition candidates A that have been studied, which satisfies the limiting condition and is associated with the smallest necessary storage container number X. Therefore, according to the above described method, it is possible to accommodate the plurality of waste pieces 900 in the storage container 91 efficiently, and to reduce the necessary storage container number X, which is the number of storage containers 91 required, while satisfying the physical limiting condition required for each waste body.

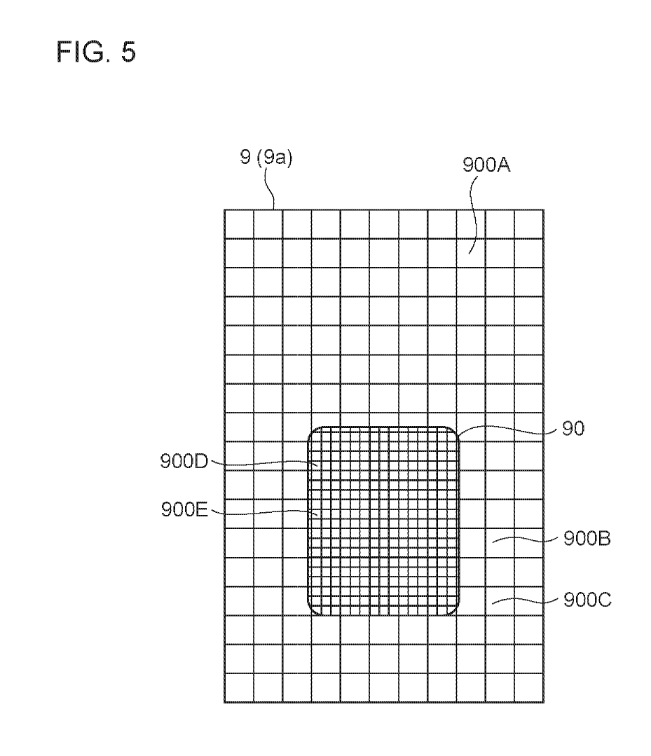

In the above described method for determining an accommodation condition, a plurality of cutting conditions may be selected for the radioactive waste 9, which contributes to reduction of the necessary storage container number X. Hereinafter, with reference to FIG. 5, an example of a method of cutting will be described, which determines the cutting manner for cutting the radioactive waste to obtain a plurality of waste pieces 900. In an embodiment, a cutting condition maybe set such that a high-dose portion of the radioactive waste is cut in small intervals (into small particle size) and a low-dose portion is cut in large intervals (into large particle size). As an example of such cutting condition, FIG. 5 shows an exemplary cutting condition for cutting the reactor internal structure 9a in the reactor 1 to obtain a plurality of high-dose waste pieces 900 (e.g. 900A to 900E).

The high dose region 90 in FIG. 5 represents a portion inside the reactor where the radiation level is particularly high. In the high dose region 90, the cutting condition is set such that cutting is performed with smaller particle size than in other portions inside the reactor internal structure 9a (for instance, particle size is greater in 900A to 900C than in 900D and 900E). Accordingly, it is possible accommodate the waste pieces 900 into each storage container 91 while finely adjusting the amount of high-dose waste pieces 900 (e.g. 900D and 900E in FIG. 5) which are cut out from the high dose region 90, and thus it is possible to easily maintain the surface dose rate of each storage container 91 within the allowable range. As the cutting condition for cutting the radioactive waste to obtain a plurality of waste pieces 900, a cutting condition other than the cutting condition B shown in FIG. 5 can be used.

In some embodiments, assuming a plurality of (M) cutting conditions Bₖ that specify cutting patterns for cutting the radioactive waste 9 to obtain the plurality of waste pieces 900 (900A to 900C) (1≤k≤M, where M is an integer not less than two), for each of the plurality of cutting conditions Bₖ, the step of selecting an arrangement condition candidate Aⱼ and the step of calculating the necessary storage container number X are performed, and a combination of a cutting condition B and an arrangement condition candidate A such that the necessary storage container number X is minimum is specified.

For instance, in the embodiment shown in FIG. 4, from among the arrangement condition candidates in a case where the radioactive waste 9 is cut in accordance with the cutting condition B₁, the arrangement condition candidates A₁ and A₂ are selected as conditions that satisfy the limiting condition. The necessary storage container numbers X corresponding to the arrangement condition candidates A₁ and A₂ are five and four, respectively. Similarly, from among the arrangement condition candidates in a case where the radioactive waste 9 is cut in accordance with the cutting condition B₂, the arrangement condition candidates A₅ and A₆ are selected as conditions that satisfy the limiting condition. The necessary storage container numbers X corresponding to the arrangement condition candidates A₅ and A₆ are six and five, respectively. Similarly, from among the arrangement condition candidates in a case where the radioactive waste 9 is cut in accordance with the cutting condition B₃, the arrangement condition candidate A₈ is selected as a condition that satisfy the limiting condition. The necessary storage container number X corresponding to the arrangement condition candidate A₈ is six. Accordingly, in the embodiment shown in FIG. 4 as example, as a combination of a cutting condition B and an arrangement condition candidate A such that the necessary storage container number X is minimum, the combination of the arrangement condition candidate A₂ and the cutting condition B₁ is specified.

As described above, according to the method described above with reference to

FIG. 5, it is possible to define various cutting manners for cutting the radioactive waste 9 to obtain the plurality of waste pieces 900 as the plurality of cutting conditions B, and calculate an accommodation condition capable of reducing the number of waste bodies 950 obtained by accommodating the waste pieces 900 in the storage containers 91 for each of the plurality of cutting conditions. As a result, according to the method described above with reference to FIG. 5, it is possible to specify the most efficient combination of a cutting condition B and an arrangement condition A, as an accommodation condition capable of reducing the number of waste bodies 950 by accommodating the waste pieces 900 into the storage containers 91 efficiently.

In some embodiments, the above method of determining an accommodation condition in a container further includes a step of obtaining the dose distribution of the radioactive waste 9. In the step of selecting an arrangement condition candidate A′ⱼ, an arrangement condition candidate A′ⱼ that satisfies the limiting condition defining at least that the surface dose rate of the waste body 950 (950A to 950C) is not higher than the threshold may be selected, on the basis of the obtained dose distribution.

When discarding or storing the waste bodies 950 (950A to 950C), it may be necessary to ensure safety and efficiency. The above method is beneficent in such cases. That is, according to the above method, the surface dose rate of each waste body 950 is set to be not higher than the threshold on the basis of the dose distribution of the radioactive waste 9, and thereby it is possible to reduce the number of necessary storage container number X, which is a number of storage containers required, while ensuring safety and efficiency in discarding or storing the waste body 950.

In some embodiments, the above method of determining an accommodation condition in a container further includes a step of measuring the dose distribution of the radioactive waste 9. In the step of selecting an arrangement condition candidate A′ⱼ, an arrangement condition candidate A′ⱼ that satisfies the limiting condition defining at least that the surface dose rate of the waste body 950 (950A to 950C) is not higher than the threshold may be selected, on the basis of the measured dose distribution.

When discarding or storing the waste bodies 950 (950A to 950C), it may be necessary to ensure safety and efficiency. The above method is beneficent in such cases. That is, according to the above method, the surface dose rate of each waste body 950 is set to be not higher than the threshold on the basis of the dose distribution of the radioactive waste 9, and thereby it is possible to reduce the number of necessary storage container number X, which is a number of storage containers required, while ensuring safety and efficiency in discarding or storing the waste bodies 950.

Accordingly, in at least one embodiment of the present invention, the storage container 91 in which each waste piece 900 is to be stored and an accommodation position in the storage container are defined by the arrangement condition candidate A. Further, in at least one embodiment of the present invention, from among the plurality of arrangement condition candidates Aᵢ (1≤i≤N), as an accommodation condition for accommodating waste pieces into a storage container, the arrangement condition candidate A₀ is determined, which is capable of reducing the necessary storage container number X, which is a number of storage containers 9 required to accommodate the plurality of waste pieces 900. Thus, according to at least one embodiment of the present invention, when accommodating the plurality of waste pieces 900 into at least one storage container 91 to obtain at least one waste body 950, it is possible to calculate an accommodation condition capable of reducing the amount of waste bodies 950.

In an embodiment, on the basis of the dose distribution, the arrangement condition candidate Aⱼ satisfying the limiting condition which defines at least that the surface dose rate of the waste body 950 is not higher than the threshold may be selected as follows.

For instance, for each case in which the radioactive waste 9 is cut in accordance with the plurality of cutting conditions Bₖ (1≤k≤M, where M is an integer not less than two), information on the dose of each waste piece 900 is obtained. At this time, the dose information of each waste piece 900 is managed in association with the corresponding cutting condition Bₖ. Accordingly, assuming that the plurality of waste pieces 900 cut under the particular cutting condition Bₖ are accommodated in the storage container 91 in accordance with the particular arrangement condition candidate A′ⱼ, it is possible to obtain the surface dose rate of the waste body 950 by combining the dose information per waste piece 900 for the plurality of waste pieces 900. Furthermore, it is determined whether the surface dose rate of the waste body 950 is not higher than the threshold, and thereby it is determined whether the arrangement condition candidate A′ⱼ satisfies the above limiting condition.

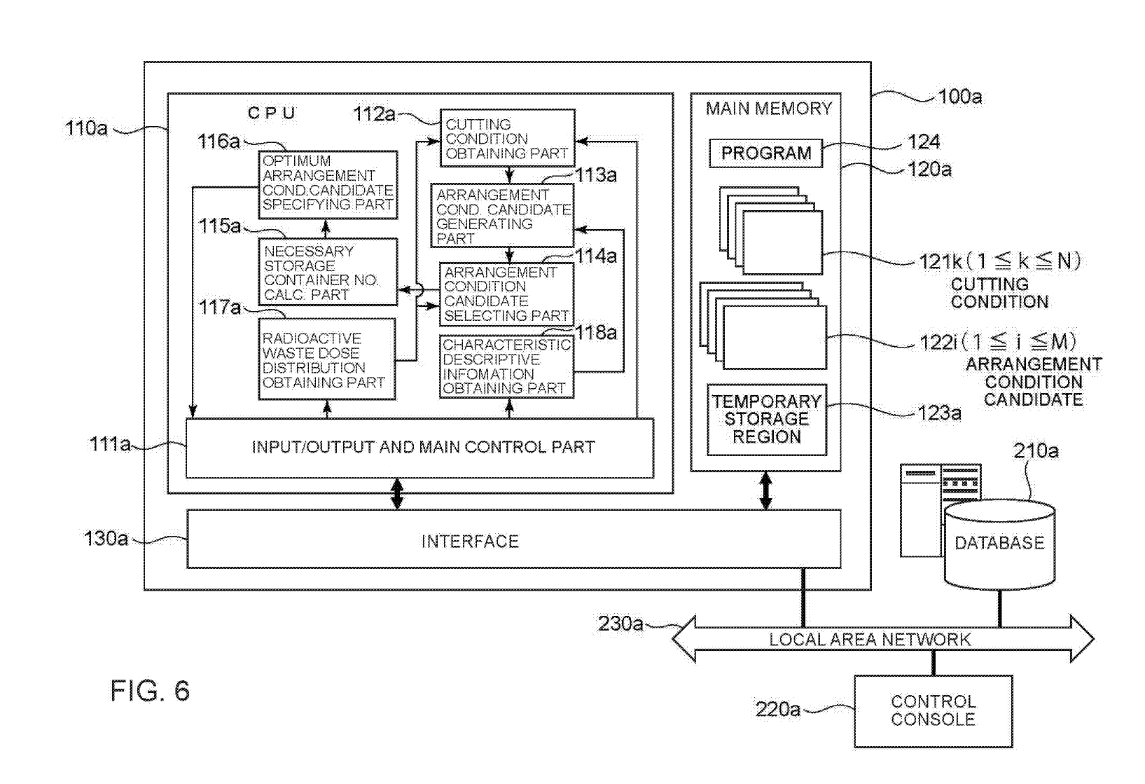

In an embodiment, the above described container accommodation condition determining method may be performed by using a computer program executed on a computer. For instance, in an embodiment, the above described container accommodation condition determining method may be performed by using a computer program 124 executed on a computer system 10 shown in FIG. 6.

The computer system 10 includes a computer 100a, a database 210a, and a control console 220 connected mutually to one another so as to be communicable via a local area network 230a. The computer 100a executes the computer program 124 in response to command from the control console 220a. The database 201a identifies each of one or more waste bodies 950 with identification information of a tug associated with each waste body 950, and stores characteristic descriptive information describing the physical characteristic condition of each waste body 950 in association with each waste body 950. The control console 220a may function as a terminal for a system user to provide command and information for the computer program 124 on the computer 100a, and for showing outputs of the computer program 124 on a display.

The computer 100a includes a CPU 110a, a main memory 120a, and an interface 130a. The CPU 110a reads and runs the computer program 124 stored on the main memory 120a. The main memory 120a stores information related to the plurality of (N) cutting conditions 121k (1≤k≤N)and the plurality of (M) arrangement condition candidates 122ᵢ (1≤i≤M). Furthermore, the main memory 120a stores data representing information other than the above in a temporary storage region 123a. The interface 130a provides a communication path for sending and receiving data and control signals between the CPU 110a, the main memory 120a, and the local area network 230a. The plurality of program modules or function constituting the computer program 124 may be read by the CPU 110a from the main memory 120a and executed as function modules 11a to 118a.

The input/output and main control part 111a functions as an input/output part for the above described function modules 112a to 118a to send and receive data and command signals between the main memory 120a, the database 210a, and the control console 220a. Furthermore, the input/output and main control part 111a has a role to control the overall flow of the series of processing operations executed by the above described function modules 112a to 118a. For instance, the series of processing operations executed by the above described modules 112a to 118a need to be executed repeatedly by loop control until finding a combination of a cutting condition and an arrangement condition candidate such that the necessary number of the storage container is minimum when all of the waste pieces are accommodated. Thus, the input/output and main control part 111a calls out the above described function modules 112a to 118a repeatedly for the number of repetitive executions controlled by the above loop control.

The arrangement condition candidate generating part 113a generates each of the plurality of arrangement condition candidates 122ᵢ (1≤i≤M) defining the storage container 91 in which each of the waste pieces 900 is to be stored and the accommodation position inside the storage container 91. Next, the arrangement condition candidate selecting part 114a having received the plurality of arrangement condition candidates 122ᵢ (1≤i≤M) generated by the arrangement condition candidate generating part 113a selects, assuming that the waste pieces 900 are arranged inside the storage container 91 in accordance with the plurality of arrangement condition candidates 122ᵢ (1≤i≤M), one or more arrangement condition candidates 122j (1≤j≤M) that satisfy the limiting condition required for the waste body, in each storage container 91.

After receiving the selected one or more arrangement condition candidates 122j (1≤j≤M), the necessary storage container number calculation part 115a calculates the necessary storage container number X, which is the number of storage containers 91 required to accommodate the plurality of waste pieces 900 in accordance with the selected arrangement condition candidate 122j (1≤j≤M). After receiving the plurality of arrangement condition candidates 122j (1≤j≤M) and the necessary storage container number X calculated for each arrangement condition from the necessary storage container number calculation part 115a, the optimum arrangement condition candidate specifying part 116a specifies the arrangement condition candidate 122⁽⁰⁾ such that the necessary storage container number X is minimum, and outputs the same to the input/output and main control part 111a.

In at least one embodiment, the above process executed by the function modules 113a to 118a may be executed for each of the plurality of cutting conditions 121k (1≤k≤N) of the radioactive waste. In such an embodiment, the cutting condition obtaining part 112a obtains the plurality of cutting conditions 121k (1≤k≤N) and stores the obtained cutting conditions 121k (1≤k≤N) in the main memory 120a. Next, the process for selecting the arrangement condition candidate 122j (1≤j≤M) and the process for calculating the necessary storage container number X are obtained by the cutting condition obtaining part 112a, and repeatedly executed for each of the plurality of cutting conditions 121k (1≤k≤N) stored in the main memory 120a. As a result, the optimum arrangement condition candidate specifying part 116a specifies a combination of the cutting condition 121k (1≤k≤N) and the arrangement condition candidate 122j (1≤j≤M) such that the necessary storage container number X is minimum.

In at least one embodiment, the cutting condition obtaining part 112a may obtain the characteristic descriptive information representing the characteristics of each of the plurality of waste pieces 900 on the basis of a measurement result of the dose distribution of the radioactive waste 9, and store the same in the database 210a. Furthermore, in at least one embodiment, in the process of selecting the arrangement condition candidate 122j (1≤j≤M), the following operation may be executed. First, the characteristic descriptive information obtaining part 118a is instructed to obtain the characteristic descriptive information stored in the database 210a. Next, on the basis of the obtained characteristic descriptive information, the arrangement condition candidate selecting part 114a determines whether the limiting condition required for each waste body 950 is satisfied in each of the storage containers 91, in a case where the waste pieces 900 are arranged inside the storage container 91 in accordance with the arrangement condition candidate 122j (1≤j≤M).

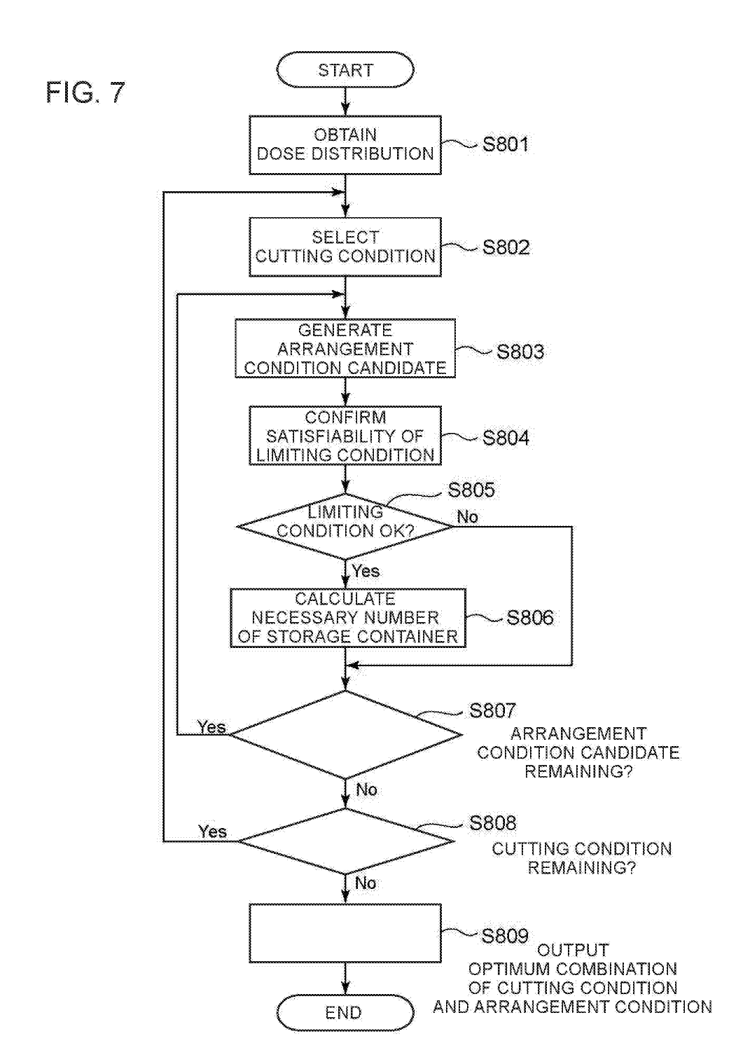

Hereinafter, the flow of the series of processing operations executed by the function modules 111a to 118a shown in FIG. 6 will be described along the flowchart of FIG. 7. The flowchart of FIG. 7 starts from the step S801, as the input/output and main control part 111a calls the dose distribution obtaining part 117a. The dose distribution obtaining part 117a obtains the dose distribution measurement data related to the radioactive waste before being cut into the plurality of waste pieces 900, and sends the dose distribution measurement data to the cutting condition obtaining part 112a via the main memory 120a.

Next, the cutting condition obtaining part 112a obtains the plurality of cutting conditions 121k (1≤k≤N) of the radioactive waste referring to the dose distribution measurement data, and stores the obtained cutting conditions 121k (1≤k≤N) in the main memory 120a. The arrangement condition candidate generating part 113a reads out the plurality of cutting conditions 121k (1≤k≤N) from the main memory 120a, and selects one unselected cutting condition 121′ from among the plurality of cutting conditions 121k (1≤k≤N). Next, in step S803, the arrangement condition candidate generating part 113a generates one arrangement condition candidate 122j on the basis of the selected cutting condition 121′, and stores the same in the main memory 120a.

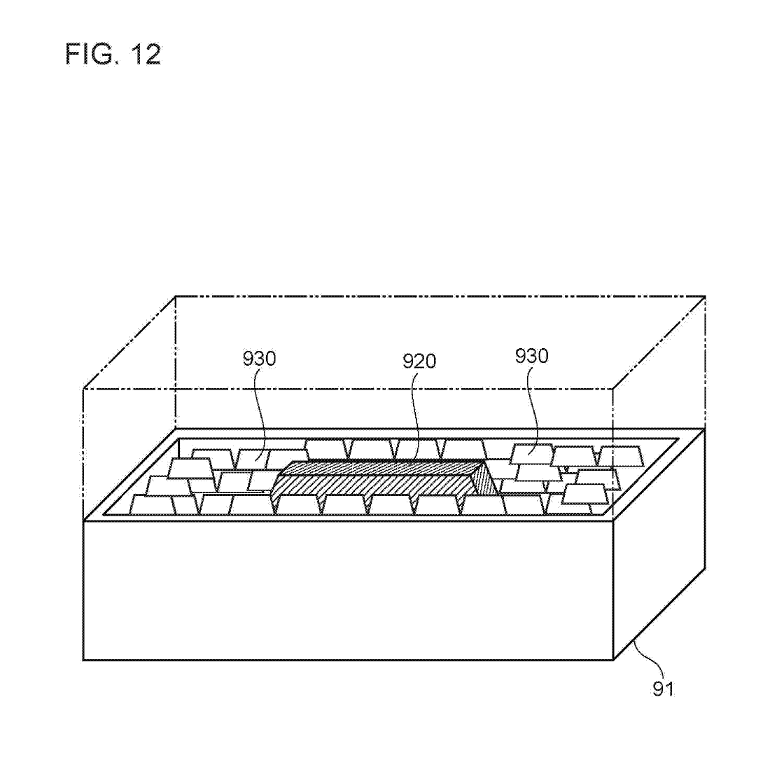

Next, in step S804, the arrangement condition candidate selecting part 114a reads out the arrangement condition candidate 122j from the main memory 120a, and determines whether the arrangement condition candidate 122j satisfies the limiting condition required for each waste body, by using the characteristic descriptive information of each waste piece obtained from the arrangement condition candidate generating part 113a. Next, in the step S 805, if the arrangement condition candidate selecting part 114a determines that the arrangement condition candidate 122j satisfies the predetermined limiting condition, the process advances to the step S806 in FIG. 7. If not, the process advances to the step S807 in FIG. 7. In step S805, the arrangement condition candidate selecting part 114a may select the arrangement condition candidate described below as follows, with reference to FIG. 12, as an arrangement condition candidate satisfying the above limiting condition. Specifically, the arrangement condition candidate selecting part 114a may select, as an arrangement condition candidate satisfying the above limiting condition, the arrangement condition candidate such that a low-dose waste piece 930 (FIG. 12) envelops a high-dose waste piece 920 (FIG. 12) disposed in the center section inside the storage container 91.

In the step S806 of FIG. 7, the necessary storage container number calculation part 115a calculates the necessary storage container number X for the arrangement condition candidate 122j, when receiving the arrangement condition candidate 122j determined by the arrangement condition candidate selecting part 114a to be a candidate satisfying the limiting condition. The necessary storage container number X is a predicted value of the number of storage containers 91 required to accommodate all of the plurality of waste pieces 900 in at least one storage container 91, in accordance each arrangement condition candidate. After the necessary storage container number calculation part 115a calculates the necessary storage container number X, the process advances to the step S807 in FIG. 7.

In the step S807 of FIG. 7, the arrangement condition candidate generating part 113a determines whether another arrangement condition candidate can be generated from the plurality of waste pieces 900 obtained by cutting the radioactive waste in accordance with the currently selected cutting condition 121′. If another arrangement condition candidate can be generated, the process returns to the step S803 of FIG. 7, and the arrangement condition candidate generating part 113a generates another arrangement condition candidate from the plurality of waste pieces 900 obtained by cutting the radioactive waste in accordance with the currently selected cutting condition 121′. In the step S807 of FIG. 7, if the arrangement condition candidate generating part 113a determines that no more arrangement condition candidate can be generated from the plurality of waste pieces 900 obtained in accordance with the currently selected cutting condition 121′, the process advances to the step S808 of FIG. 7.

In the step S808 of FIG. 7, the cutting condition obtaining part 112a determines whether there is a remaining cutting condition not selected for the process from the steps S802 to S807 of FIG. 7, among the plurality of cutting conditions 121k (1≤k≤N) stored in the main memory 120a. If there is a remaining unselected cutting condition, the process returns to the step S802, and the cutting condition obtaining part 112a re-selects an unselected cutting condition from among the plurality of cutting conditions 121k (1≤k≤N) stored in the main memory 120a. If there is no remaining cutting condition unselected in the plurality of cutting conditions 121k (1≤k≤N), the process advances to the step S809.

In the step S809, the optimum arrangement condition candidate specifying part 116a receives the plurality of arrangement condition candidates and the necessary storage container number X calculated for each arrangement condition from the necessary storage container number calculation part 115a, for all of the plurality of cutting conditions 121k (1≤k≤N). Next, the optimum arrangement condition candidate specifying part 116a specifies an efficient combination of an arrangement condition candidate and a cutting condition such that the necessary number of the storage container 91 is minimum, from among the necessary storage container numbers X calculated for each of the arrangement condition candidates for each of the plurality of cutting conditions 121k (1≤k≤N). Finally, the optimum arrangement condition candidate specifying part 116a outputs the specified optimum combination of the arrangement condition candidate and the cutting condition to the input/output and main control part 111a.

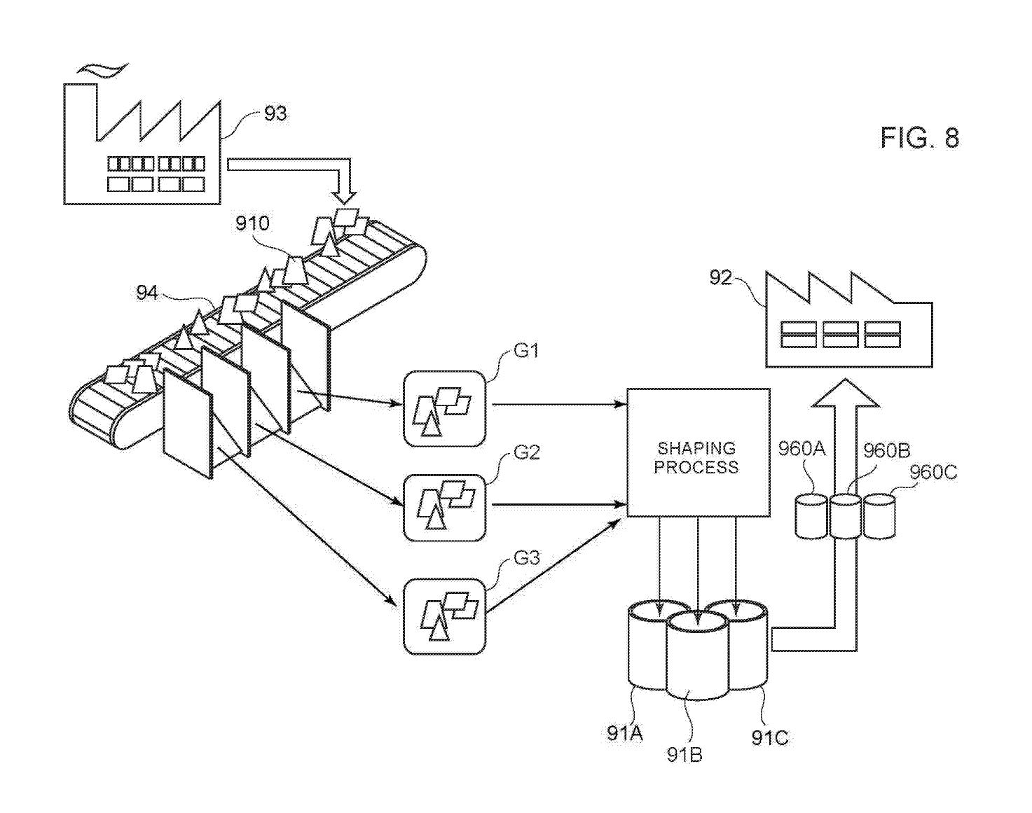

Next, a modified example for implementing the one or more embodiments described herein with partial correction will be described with reference to FIG. 8. For instance, as described above with reference to FIG. 5, the dose of each waste piece may differ depending on the location of cutting out the waste pieces 900 even within the same radioactive waste 9 (e.g. high-dose region 90 and the remaining region shown in FIG. 5).

Thus, in the embodiment shown in FIG. 8, the plurality of waste pieces 910 cut out from the reactor in accordance with a predetermined cutting condition and discharged from the nuclear power plant 93 may be sorted by dose. For instance, in an exemplary embodiment, the plurality of waste pieces 900 are sorted by a sorter 94 into high-dose pieces (G1 in FIG. 8), mid-dose pieces (G2 in FIG. 8), and low-dose pieces (G3 in FIG. 8). Next, in the present modified embodiment, in order to increase the filling rate of the waste pieces in each waste body and decrease the number of waste bodies, an appropriate shaping process is performed on the waste pieces 900 sorted by dose. Next, in the modified embodiment, the arrangement condition capable of producing the necessary number of storage containers is determined. In accordance with the determined arrangement condition, all of the waste pieces 910 are accommodated inside the at least one storage container 91, to produce at least one waste body 960 (960A to 960C) and store the same in the storage building 92.

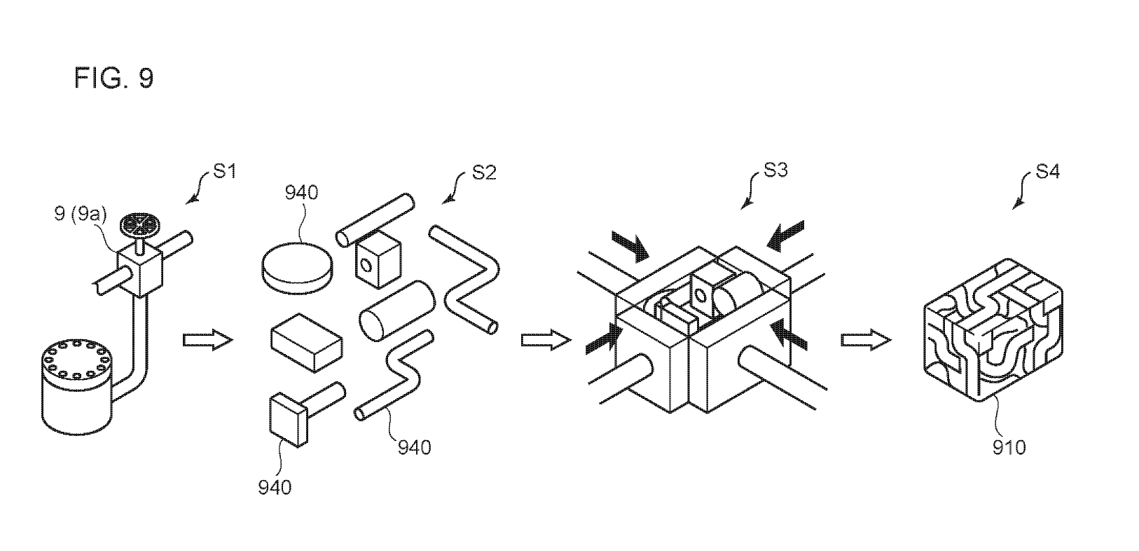

In the exemplary embodiment shown in FIG. 9, the plurality of segments 940 obtained by cutting the radioactive waste 9 are shaped by compression to obtain a plurality of waste pieces having a standardized shape (including dimension), and then the plurality of waste pieces 910 may be accommodated in the at least one storage container 91 in accordance with a suitable arrangement condition. Hereinafter, the standardized shape (including dimension) of the waste piece will be referred to as standardized shape.

In an exemplary embodiment, for example, a standardized shape may a shape having dimensions of length, width, and height obtained by dividing the length of the long side, the length of the short side, and the depth, respectively, of the accommodation space cross section inside the storage container 91 by an appropriate integer, rounding down the fractions. Furthermore, as an example of the method of determining the standardized shape, the waste pieces 910 may be shaped by compression so that the length, width, and height dimensions of the waste pieces 910 become the dimensions obtained by dividing the length of the long side the length of the short side, and the depth, respectively, of the accommodation space cross section inside the storage container 91 by an appropriate integer, rounding down the fractions. More specifically, provided that Lx, Ly, and Lz are the length of the long side, the length of the short side, and the depth of the accommodation space cross section inside the storage container 91, respectively, appropriate integers α, β, and γ may be used to calculate the dimensions lx, ly, and lz, of the length, width, and height of the standardized shape.

(Expression 1)

lx=└Lx/α┘, ly=└Ly/β┘, lz=└Lz/γ┘ (1)

In an exemplary embodiment, the above described compression shaping process may be performed by a cutting process, a compression process, a melting process, or combination of the above, for the plurality of segments 940 cut out from the radioactive waste 9. In an embodiment, the radioactive waste 9 may include a reactor internal structure 9a cut by a cutting tool. In an embodiment, the plurality of segments 940 obtained by cutting the radioactive waste may be sorted according to the radiation level, by the sorter 94 shown in FIG. 8, for example.

In FIG. 9, the radioactive waste 9 (S1 in FIG. 9) is cut into the plurality of segments 940 to be scrapped (S2 in FIG. 9), and the plurality of segments 940 are shaped by compression from front and rear, right and left, and top and bottom by plate-shaped pressing members of a compressing device used for the compression shaping process (S3 in FIG. 9), so as to be shaped into cubes with standardized dimensions. Furthermore, in an embodiment, the compression shaping process described above with reference to FIG. 9 may be performed as the shaping process performed for the waste pieces 910, after sorting the waste pieces 910 by the sorter 94 in the disposal procedure shown in FIG. 8.

Furthermore, in a case where the plurality of segments 940 obtained by cutting the radioactive waste are sorted by dose as in the modified embodiment shown in FIG. 8 and the segments are shaped by compression by each of the sorted radiation levels, it is possible to provide a plurality of standardized shapes having a plurality of sizes or particle sizes corresponding to the plurality of radiation levels. For instance, a standardized shape corresponding to a high radiation level may be set to have small dimensions for a small size or a small particle size, and a standardized shape corresponding to a low radiation level may be set to have large dimensions for a large size or a large particle size. In an exemplary embodiment, the waste pieces 910 having a standardized shape having various length, width, and height dimensions corresponding to various particle sizes may be obtained as follows. Specifically, the integers α, β, and γ used to divide the above described Lx, Ly, and Lz, which are the length of the long side, the length of the short side, and the depth, of the accommodation space cross section inside the storage container 91, are adjusted in accordance with a target particle size. Then, the dimensions lx, ly, and lz of length, width, and height of the standardized shape are calculated in accordance with the above expression (1). Accordingly, the high-dose waste pieces have a standardized shape of small dimensions, and thus it is possible to prevent accommodating a great amount of high-dose pieces at once in one storage container. That is, the high-dose waste pieces have a standardized shape of small dimension, and thus it is possible to accommodate the high-dose waste pieces in each storage container while finely adjusting the amount of high-dose waste pieces, and to keep the surface dose rate of each storage container in the allowable range.

Therefore, according to the embodiment shown in FIG. 9 for example, it is possible to accommodate the waste pieces into a storage container after shaping the plurality of waste pieces obtained by cutting the radioactive waste into waste piece having a standardized shape (including dimensions). Thus, according to this embodiment, it is possible to considerably simplify the computation process for determining the accommodation condition capable of reducing the amount of waste bodies obtained by accommodating the waste pieces in the storage container, and to calculate the accommodation condition such that the waste pieces can be stuffed into the storage container with smallest possible clearance. In this case, the length, width, and height dimensions of the standardized shape adopted for the calculated accommodation condition may be determined as follows. Specifically, the integers α, β, and γ used to divide the above described Lx, Ly, and Lz, which are the length of the long side, the length of the short side, and the depth, of the accommodation space cross section inside the storage container storage container 91, are adjusted in accordance with a target particle size. Then, the dimensions lx, ly, and lz of length, width, and height of the standardized shape are calculated in accordance with the above expression (1).

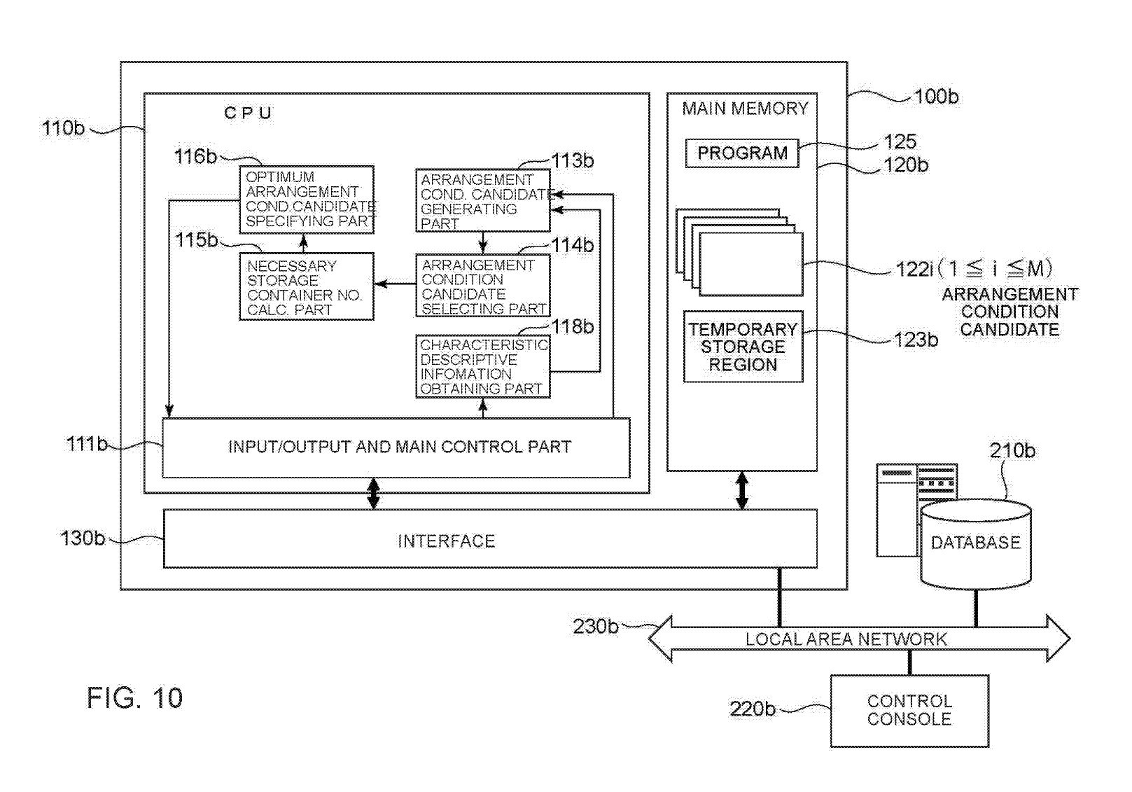

In an embodiment, the above embodiment shown in FIG. 9 may be performed by using a computer program 125 executed on a computer system 20 shown in FIG. 10, for instance. Hereinafter, for describing the system configuration according to the embodiment shown in FIG. 10, difference between the embodiment shown in FIG. 10 and the embodiment shown in FIG. 6 will be described, and the same configuration as that of the embodiment shown in FIG. 6 will not be described.

In the computer system 20 shown in FIG. 10, unlike the embodiment shown in FIG. 6, all of the waste pieces 910 are treated as being shaped into a simple standardized shape, and an efficient arrangement condition candidate can be determined without taking into account the plurality of cutting conditions. Furthermore, in the embodiment shown in FIG. 10, the surface dose rate, heat generation amount, and weight of the plurality of waste pieces 910 shaped into the standardized shape are obtained by preliminary actual measurement described below, and the actual measurement values are recorded in the database 201b. In an embodiment, the preliminary process may be performed involving a worker inside the nuclear power plant, prior to determination of the efficient arrangement condition candidate using the computer system 20. Furthermore, the characteristic descriptive information of each waste piece includes an actual measurement value actually measured in advance as described above for each of the plurality of waste pieces 910, and also may include information related to the kind of standardized shape if two or more standardized shapes are defined corresponding to a plurality of radiation levels.

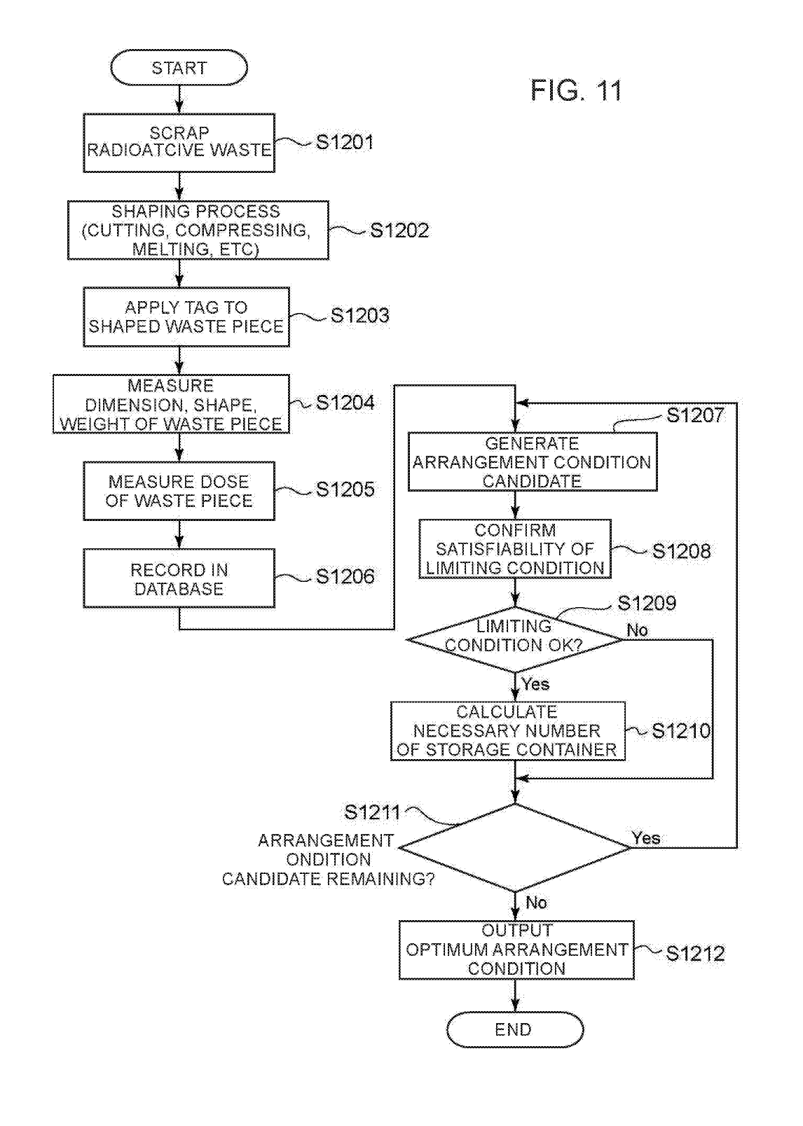

Hereinafter, the overall process flow of the embodiment shown in FIG. 10 will be described along the flowchart in FIG. 11. In the flowchart described in FIG. 11, the steps S1201 to S1206 correspond to the above described preliminary process, and include a process of compressing the plurality of segments obtained by cutting the radioactive waste and shaping the segments into the plurality of waste pieces having at least one kind of standardized shape, and a process of measuring the weight, dose, and heat generation amount of each of the waste pieces. In the flowchart shown in FIG. 11, the steps S1207 to S1212 correspond to the processes executed by the function modules 113 to 118 constituting the computer program 125 to determine the efficient arrangement condition candidate by using the computer system 20.

The process of the flowchart in FIG. 11 starts from the step S1201, and the radioactive waste is cut into a plurality of segments to be scrapped. Next, the process advances to the step S1202, and the plurality of segments are shaped to have a standardized shape. In a case where the plurality of segments are sorted by radiation level, the plurality of segments may be shaped in accordance with two or more kinds of standardized shape having different dimensions, for different radiation levels, to obtain the plurality of waste pieces 910.

Next, the process advances to the step S1203, and a tag is applied to each of the plurality of waste pieces 910. The tag applied to each of the plurality of waste pieces 910 includes records of identification information for specifically identifying each of the waste pieces 910. Next, the process advances to the step S1204, and the weight per waste piece is actually measured for each of the plurality of waste pieces. Furthermore, if two or more types of standardized shape are defined, it is also determined which type of standardized shape the plurality of waste pieces have. Next, the process advances to the step S1205, and the surface dose rate and heat generation amount per waste piece are actually measured for each of the plurality of waste pieces. Next, the process advances to the step s1206, and information is recorded on the database 210b, which represents the weight, type of standardized shape, surface dose rate, and heat generation amount, per waste piece actually measured or determined as described above, for each of the plurality of waste pieces. At this time, the information representing the weight, type of standardized shape, surface dose rate, and heat generation amount, per waste piece is recorded on the database 201b in association with the identification information per waste piece recorded on the tag attached to each of the plurality of waste pieces 910.

Next, the process advances to the step S1207 and so on. The steps S1207 to S1211 are similar to the steps S803 to S807 in FIG. 7, and the step S1212 is similar to the step S809 except that the cutting conditions are not considered. In step S1209, the arrangement condition candidate selecting part 114b may select the arrangement condition candidate described below as follows, with reference to FIG. 12, as an arrangement condition candidate satisfying the above limiting condition. Specifically, the arrangement condition candidate selecting part 114b may select, as an arrangement condition candidate satisfying the above limiting condition, the arrangement condition candidate such that low-dose waste pieces envelop a high-dose waste piece 910 disposed in the center section inside the storage container 91.

Another embodiment of the present invention will now be described in reference to FIG. 12. In the present embodiment, when accommodating the plurality of waste pieces 900 obtained by at least cutting the radioactive waste 9 (9a) and obtaining at least one waste body 950, the first waste piece 920 may be accommodated in the first region positioned in the center section of the storage container 91, and the second waste pieces 930 having a lower dose than the first waste piece 920 may be accommodated in the second region surrounding the first region inside the storage container 91, such that the second waste pieces 930 envelop the first waste piece 920.

Accordingly, if the selected arrangement condition candidate defines an arrangement (FIG. 12) such that the low-dose waste pieces 930 envelop the high-dose waste piece 920 inside the storage container 91, it is possible to reduce the dose that reaches the surface of the waste body 950 thanks to the function as the radiation insulator of the low-dose waste pieces 930 enveloping the high-dose waste piece 920, even in a case where the high-dose waste 920 is disposed inside the storage container 91. Thus, if the plurality of arrangement condition candidates 122ᵢ (1≤i≤M) include a candidate defining the arrangement manner of the waste pieces as shown in FIG. 12, it is possible to increase the possibility of the arrangement condition candidate satisfying the limiting condition, even in a situation where few storage containers 91 are available and a large number of high-dose waste pieces 920 need to be accommodated in the container 91. As a result, compared to a typical accommodation method, it is possible to accommodate more high-dose waste pieces 920 inside the storage container 91, even if the number of available storage containers is limited. Thus, it is possible to increase the filling rate of the waste pieces 900 inside the storage container 91, and to reduce the number of waste bodies 950 compared to a typical accommodation method.

Furthermore, in the container accommodation condition determining method according to the embodiment with reference to FIGS. 1 to 11, the plurality of arrangement condition candidates 122ᵢ (1≤i≤M) may include at least one arrangement condition candidate such that the first waste piece 920 is accommodated in the first region positioned in the center section of the storage container 91, and the second waste pieces 930 having a lower dose than the first waste piece 920 are accommodated in the second region surrounding the first region inside the storage container 91 so as to envelop the first waste piece 920. For instance, in the step S803 in the step FIG. 7 and the step S1207 in FIG. 11, the arrangement condition candidate generating parts 113a and 113b may include, in the plurality of arrangement condition candidates 122ᵢ (1≤i≤M), an arrangement condition candidate determining the arrangement manner for the waste pieces 920, 930 described above.

Accordingly, if the selected arrangement condition candidate defines an arrangement (FIG. 12) such that the low-dose waste pieces 930 envelops the high-dose waste piece 920 inside the storage container 91, it is possible to reduce the dose that reaches the surface of the waste body 950 thanks to the function as the radiation insulator of the low-dose waste pieces 930 enveloping the high-dose waste piece 920, even in a case where the high-dose waste piece 920 is disposed inside the storage container 91. Thus, if the plurality of arrangement condition candidates include a candidate defining the arrangement manner of the waste pieces as shown in FIG. 12, it is possible to increase the possibility of the arrangement condition candidate satisfying the limiting condition, even in a situation where few storage containers 91 are available and a large number of high-dose waste pieces 920 need to be accommodated in the container 91. As a result, compared to a typical accommodation method, it is possible to accommodate more high-dose waste pieces 920 inside the storage container 91, even if the number of available storage containers is limited. Thus, it is possible to increase the filling rate of the waste pieces 900 inside the storage container 91, and to reduce the number of waste bodies 950 compared to a typical accommodation method.

### DESCRIPTION OF REFERENCE NUMERALS

1 Reactor
9 Radioactive waste
9a Reactor internal structure
10, 20 Computer system
90 High dose region
91A, 91B, 91C, 91D Storage container
92 Storage building
93 Nuclear power plant
94 Sorter
100a, 100b Computer
110a, 100b CPU
111a, 111b Input/output and main control part
112a, 112b Cutting condition obtaining part
113a, 113b Arrangement condition candidate generating part
114a, 114b Arrangement condition candidate selecting part
115a, 115b Necessary storage container number calculation part
116a, 116b Optimum arrangement condition candidate specifying part
120a, 120b Main memory
121k (121k (1≤k≤N), 121′) Cutting condition
122 (122ᵢ (1≤i≤M), 122′) Arrangement condition candidate
123a, 123b Temporary storage region
124, 125 Computer program
130a, 130b Interface
210a, 210b Database
220a, 220b Control console
900 (900A, 900B, 900C, 900D, 900E) Waste piece
910, 920, 930 Waste piece
940 Segment
950, 960 Waste body

1.-12. (canceled)

13. A container accommodation condition determination method of determining an accommodation condition for accommodating a plurality of waste pieces, obtained by at least cutting radioactive waste, into at least one storage container, for obtaining at least one waste body by accommodating the plurality of waste pieces into the at least one storage container, the method comprising:
a step of obtaining dose information of each of the plurality of waste pieces;
a step of, assuming, for each of a plurality of arrangement condition candidates specifying the storage container in which each of the waste pieces is to be stored and an accommodation position inside the storage container, that the waste pieces are arranged inside the storage container in accordance with the arrangement condition candidate, selecting at least one of the arrangement condition candidates which satisfy a limiting condition required for the waste body in each of the storage containers;
a step of calculating a necessary storage container number which is the number of the storage container required to accommodate the plurality of waste pieces in accordance with the selected arrangement condition candidate; and
a step of specifying the arrangement condition candidate such that the necessary storage container number is minimum,
wherein the step of selecting the arrangement condition candidate includes
obtaining a surface dose rate of the waste body in a case where each of the waste pieces is arranged at the accommodation position in the storage container specified by the arrangement condition candidate on the basis of the dose information of each of the waste pieces, and
selecting the arrangement condition candidate satisfying the limiting condition at least specifying that the surface dose rate of the waste body is not higher than a threshold.

14. The container accommodation condition determination method according to claim 13, comprising
performing, for each of a plurality of cutting conditions for cutting the radioactive waste, the step of selecting the arrangement condition candidate and the step of calculating the necessary storage container number, and
specifying a combination of the cutting condition and the arrangement condition candidate such that the necessary storage container number is minimum.

15. The container accommodation condition determination method according to claim 13, further comprising
a step of measuring a dose distribution of the radioactive waste,
wherein the step of selecting the arrangement condition candidate includes selecting the arrangement condition candidate satisfying the limiting condition which at least specifies that a surface dose rate of the waste body is not higher than a threshold on the basis of the dose distribution.

16. The container accommodation condition determination method according to claim 13, further comprising
a step of obtaining a dose of each of the waste pieces,
wherein the step of selecting the arrangement condition candidate includes selecting the arrangement condition candidate satisfying the limiting condition which at least specifies that a surface dose rate of the waste body is not higher than a threshold on the basis of the dose of the waste pieces.

17. The container accommodation condition determination method according claim 13, further comprising a step of storing, in a database, characteristic descriptive information showing a characteristic of each of the plurality of waste pieces,
wherein the step of selecting the arrangement condition candidate includes determining whether the limiting condition required for the waste body is satisfied in each of the storage containers when the waste pieces are arranged in the storage containers in accordance with the arrangement condition candidate, on the basis of the characteristic descriptive information stored in the database.

18. The container accommodation condition determination method according to claim 17,
wherein the character specific information includes at least one of a shape, a weight, or a dose, of each of the waste pieces.

19. The container accommodation condition determination method according to claim 13, further comprising a step of compressing a plurality of segments obtained by cutting the radioactive waste to shape the segments into the plurality of waste pieces having at least one kind of standardized shape.

20. The container accommodation condition determination method according to claim 13, wherein the limiting condition required for the waste body includes a condition such that at least one of a weight, a surface dose rate, or a heat generation amount, of each of the waste bodies is within an allowable range.

21. The container accommodation condition determination method according to claim 13,
wherein the plurality of arrangement condition candidates include at least one arrangement condition candidate specifying that, inside each of the storage containers, a first waste piece is accommodated in a first region disposed in a center section of the storage container and a second waste piece is disposed in a second region surrounding the first region in the storage container so as to envelope the first waste piece, the second waste piece having a lower dose than the first waste piece.

22. A radioactive waste accommodation method, comprising a step of accommodating the waste pieces inside the storage container in accordance with the accommodation condition determined by the container accommodation method determination method according to claim 13 to obtain at least one waste body.

23. A radioactive waste accommodation method of obtaining at least one waste body by accommodating a plurality of waste pieces, obtained by at least cutting radioactive waste, into at least one storage container, comprising:
a step of accommodating a first waste piece in a first region positioned in a center section of the storage container; and
a step of accommodating a second waste piece in a second region surrounding the first region in the storage container such that the second waste piece envelops the first waste piece, the second waste piece having a lower dose than the first waste piece,
wherein the first waste piece has a smaller dimension than the second waste piece.

24. A waste body comprising:
a plurality of waste pieces being fragments of radioactive waste; and
a storage container accommodating the plurality of waste pieces,
wherein the plurality of waste pieces include:
a first waste piece accommodated in a first region positioned in a center section of the storage container; and
a second waste piece accommodated in a second region surrounding the first region in the storage container such that the second waste piece envelops the first waste piece, the second waste piece having a lower dose than the first waste piece, and
wherein the first waste piece has a smaller dimension than the second waste piece.
